(19) United States
(12) Patent Application Publication
(10) Pub. No.: US 2024/0300792 A1
(43) Pub. Date: Sep. 12, 2024

(54) WORK PLATFORM WITH EXTENSION DECK AND WORK STEP, AND RELATED METHODS

(71) Applicant: CALIFORNIA MANUFACTURING AND ENGINEERING CO., LLC, Kerman, CA (US)

(72) Inventor: GARY CROOK, KERMAN, CA (US)

(21) Appl. No.: 18/666,827

(22) Filed: May 17, 2024

(51) Int. Cl. B66F 11/04

(52) U.S. Cl. CPC B66F 11/04

(57) ABSTRACT

A self-propelled aerial work platform apparatus includes a chassis and elevating work platform with operator controls thereon. The work platform includes a main deck, an extension deck and a storable work step at one end of the extension deck to allow a worker to access utilities through openings in drop ceilings. The step and attached legs are moveable together from a horizontal work position of the step to a vertically extending storage position with step and legs alongside the step close to guardrails at the end of the extension deck.

### CROSS REFERENCE TO RELATED APPLICATIONS, IF ANY

This application claims the benefit and priority of provisional application Ser. No. 62/663,465 filed Apr. 27, 2018.

### BACKGROUND OF THE INVENTION AND PRIOR ART

### Field of the Invention

This disclosure pertains to self-propelled aerial work platform apparatus, particularly small size self-propelled scissors lifts which are controllable and moveable by an operator from the work platform.

### Description of the Related Art

Scissors lifts are in widespread use in warehouses, construction sites and various other job sites. With the increasing use of low-level aerial work platforms to perform elevated work tasks in safer and more productive methods, there is a need for means to work through small overhead openings. A typical application is the need to work on utility services such as electric and communication cables, water and gas pipes and the like which are secured to structural ceilings having drop ceilings suspended below the utilities. Since access openings which may be made in the drop ceiling are typically less than 24″ wide, the work platform guardrails restrict elevation of the platform above the suspended drop ceiling thereby preventing the worker from conveniently reaching the utilities above the drop ceiling for installation, replacement or repair. This limitation causes workers to consider standing on the platform guardrail mid-rail or use a small ladder on the platform, both of which are unsafe and forbidden practices. The traditional solution is the use of a specialized “push around” personnel lift that typically has a small platform which by definition is not self-propelled. A further limitation of the push around platform type lift is that once the lift is positioned and the platform stabilizing outriggers have been set, the vertical projection of the platform is fixed in place and re-positioning of the lift and re-deployment of the outriggers may be necessary to allow a worker to enter through a tight overhead opening in the drop ceiling.

One solution of this problem is a vertical access platform attachment called SHU device offered by Man Lift Manufacturing Co. for a self-propelled scissor lift. The attachment allows a worker to reach higher but replaces the existing slide out deck and therefore not only eliminates this advantageous feature but also causes the apparatus to be significantly longer thereby making it less maneuverable in tight spaces, restriction for entering a freight elevator and for loading onto a delivery vehicle. Such devices are heavy causing the lift capacity to be reduced. In addition, the attachment is relatively expensive and not instantly available or readily installed

### SUMMARY OF THE DISCLOSURE

A platform of the type having an extension deck for use in aerial work platform apparatus. The work platform comprises a main deck and an extension deck with guardrails and an attached moveable step. Guardrails having raiseable upper sections are provided on the extension deck. The step is moveable from a work position in which it is horizontally oriented above the extension deck to a storage position when not in use.

This work platform is particularly adapted for use on small aerial work apparatus which has a self-propelled chassis and mechanism such as a scissors lift on the chassis for elevating the platform to a work position. Operator controls are provided on the work platform for positioning the apparatus and for elevating and lowering the work platform.

### BRIEF DESCRIPTION OF THE DRAWINGS

FIG. 1 is a perspective view of a work platform for an aerial work platform apparatus, the platform including an extension deck and a folding step.

FIG. 2 is a perspective view of the platform of FIG. 1 showing the step in folded position.

FIG. 3 is perspective view of the extension deck with step and associated guardrails extended.

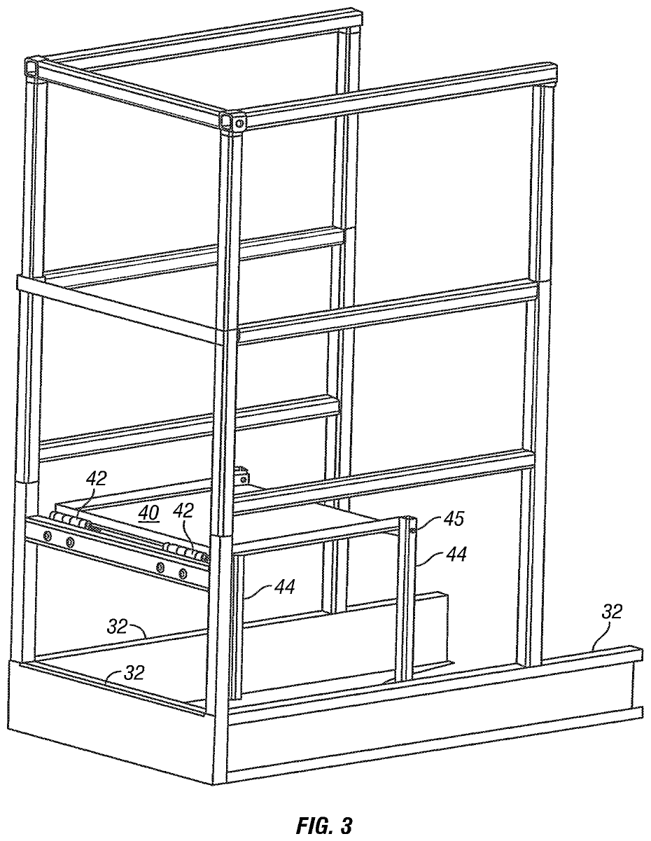

FIG. 4 is a perspective view like FIG. 3 viewed from a different angle with the step and associated guardrails stowed.

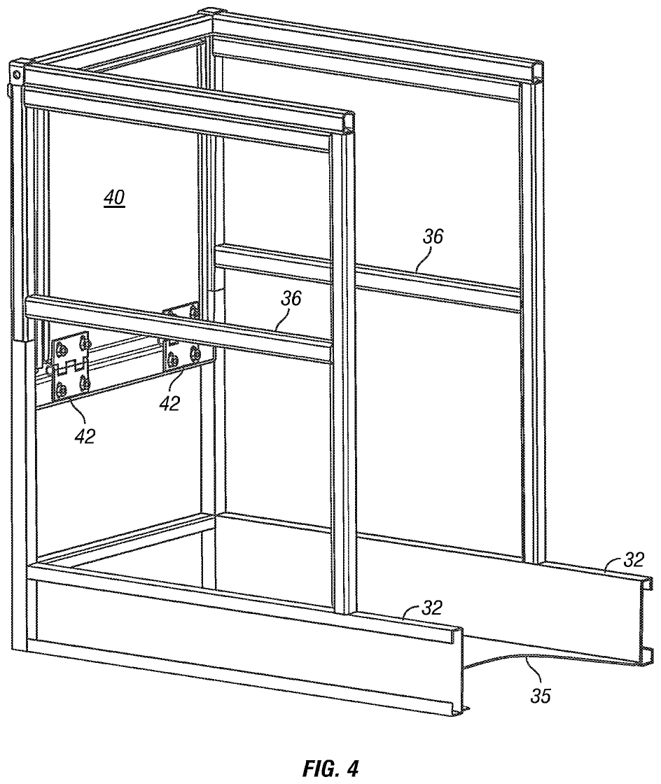

FIG. 5 is another perspective view of the entire work platform showing the extension deck extended from the main work deck with raiseable guard rails on the extension deck in a stowed position and the step in folded position.

FIG. 6 is a perspective view like FIG. 5 showing the step in operative position and guard rails associated with the step deployed in raised position.

FIG. 7 is a perspective view of the extension deck and hinged connection of the step shown in stowed position.

FIG. 8 is a perspective view of the extension deck with the step and guardrails in operative position.

FIG. 9 is a perspective view of the main deck and extension deck in retracted position.

FIG. 10 is a perspective view like FIG. 9 with the step and guardrails in operative position.

### DESCRIPTION OF PRESENTLY PREFERRED EMBODIMENT

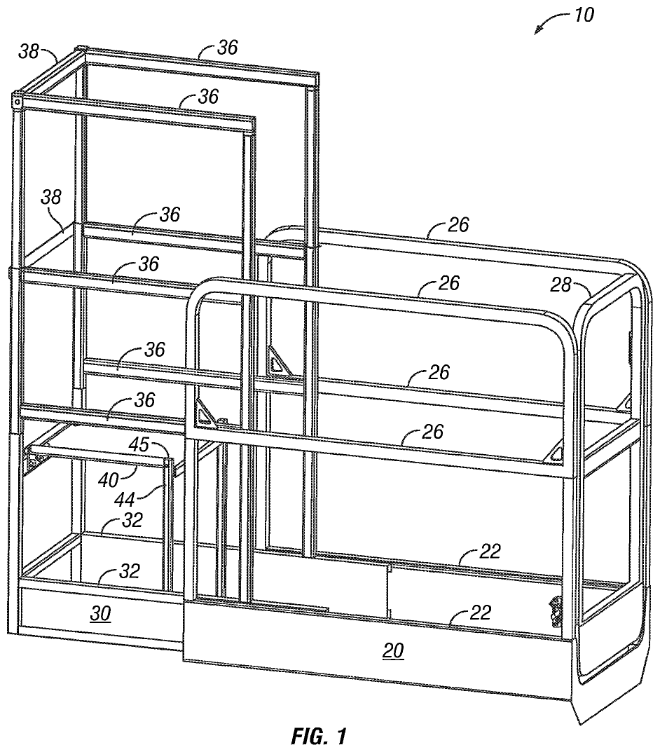

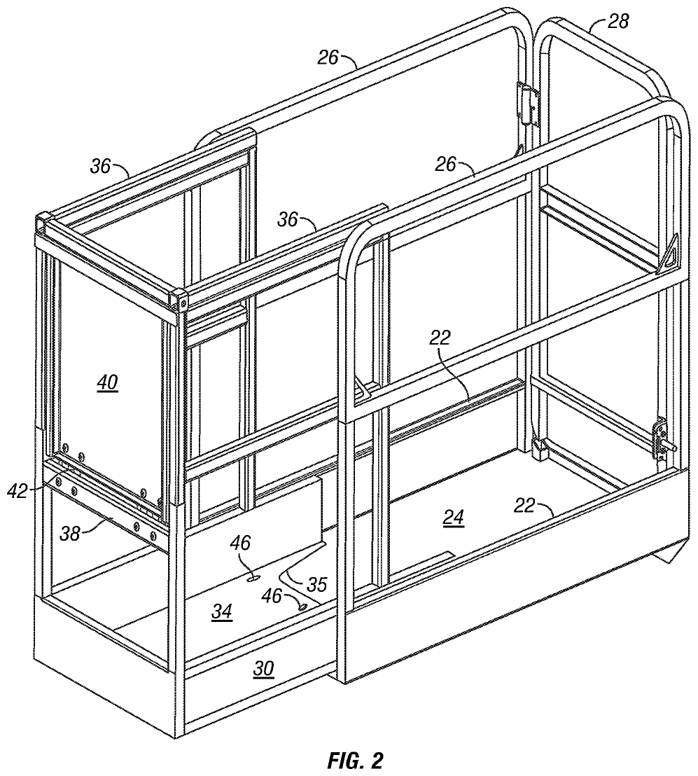

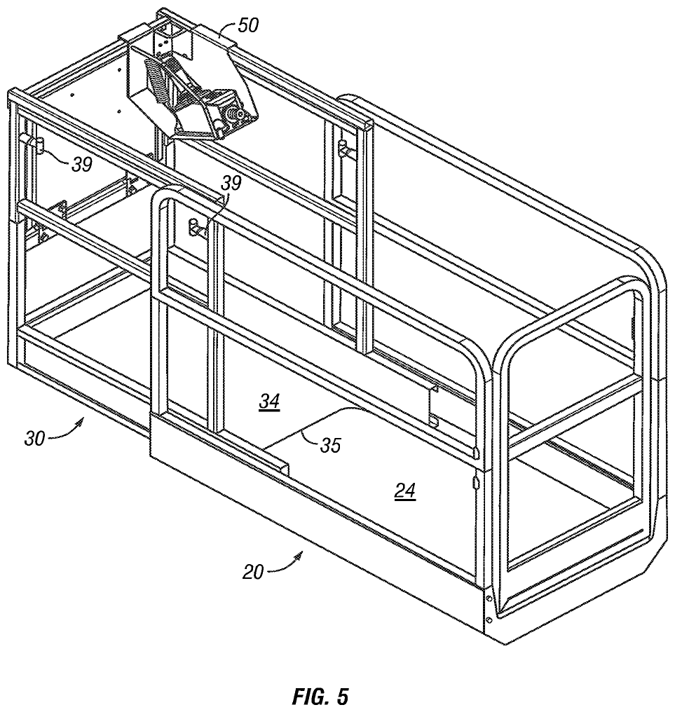

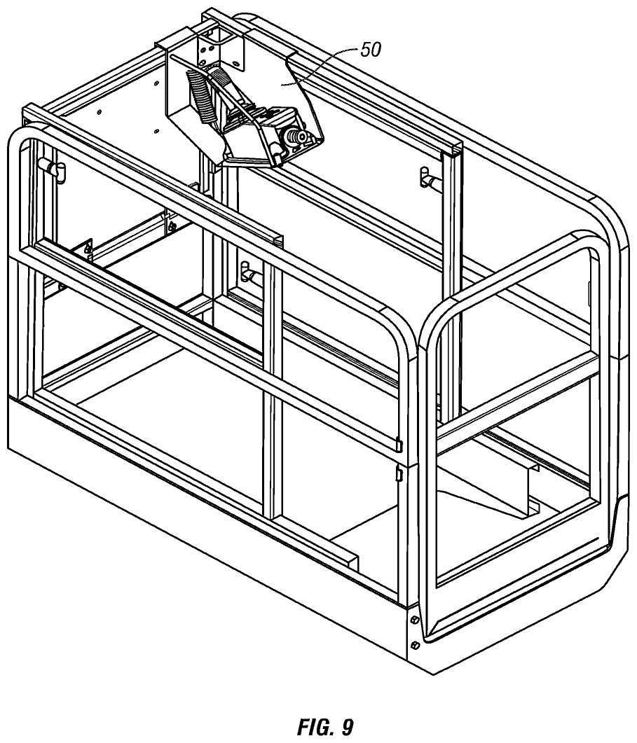

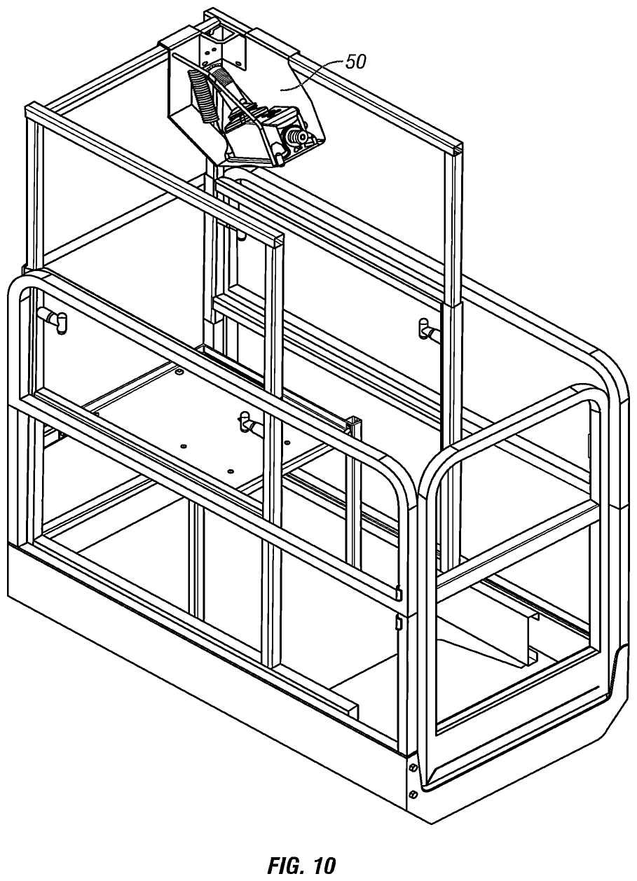

The work platform 10 is of generally rectangular configuration and includes a main deck 20, an extension deck 30 and a storable step 40 particularly useful on small aerial work apparatus such as a scissors lift. The main deck 20 of the platform includes longitudinally extending structural members 22 affixed to and supporting a generally flat floor or bottom 24, spaced side guardrails 26 and an access gate 28 at one end. The extension deck 30 includes longitudinally extending structural members 32 supporting a flat floor or bottom 34. The structural members 32 of the extension deck 30 are slideably received between and supported by the structural members 22 of the main deck such that the floor 34 of the extension deck is slightly above the floor 24 of the main deck 20. It will be noted from FIGS. 5 through 10 that the bottom 34 of the extension deck 30 has a cutout area 35 at the end facing the gate so that the operator can stand on the floor 24 of the main deck and manually extend and retract the extension deck 30 when desired. Spaced side and end guardrails 36, 38 of the extension deck 30 are sized and connected as shown such that the extension deck and its guardrails may be stowed above the main deck 20. Stops (not shown) are provided as is conventional to define the safe limits of travel of the extension deck 30. Upper sections of the side guardrails on the extension deck may be lowered from the FIG. 1 position to the FIG. 2 position by telescopically sliding the upper guardrail support legs into or alongside the guardrail support legs immediately below.

A moveable step 40 for safety purposes is preferably of rectangular configuration and extends substantially the full width of the extension deck 30 to provide an elevated step up work platform when needed. The edge of the step nearest the end of the extension deck is affixed, preferably by a pair of hinges 42, to support structure such as a guardrail cross brace 38 of the extension deck such that the unhinged end of the step 40 may be lifted from a horizontally extending working elevation above the floor 34 of the extension deck to a vertically extending storage position at the end of the extension deck when not in use. The step 40 includes pivotally connected support legs 44 preferably having configuration such as short projections at the ends thereof to be received in retainers such as positioning pockets 46 in the floor 34 of the extension deck when the step is in its horizontal work position. Applicable safety and operating instructions can be displayed on the floor 34 of the extension deck 30 to be visible when the step 40 is in its horizontally extended position and/or on the underside of the step to be visible when the step is in its vertical storage position.

Upper moveable guardrail sections of the extension deck 30 are provided to protect a worker when standing on the step 40. The upper guardrail sections may be manually lifted from lowered positions in which their vertical legs are preferably telescopically stored inside or alongside vertical legs of the lower extension deck guardrail sections. The upper sections of the guardrails 36 may be retained in either the stored position or in the work position by T handle pull pins 39 (FIGS. 5-10) which engage with holes in the vertically extending guardrail legs. If desired, powered means may be provided to assist lifting the upper guardrail sections to operable position.

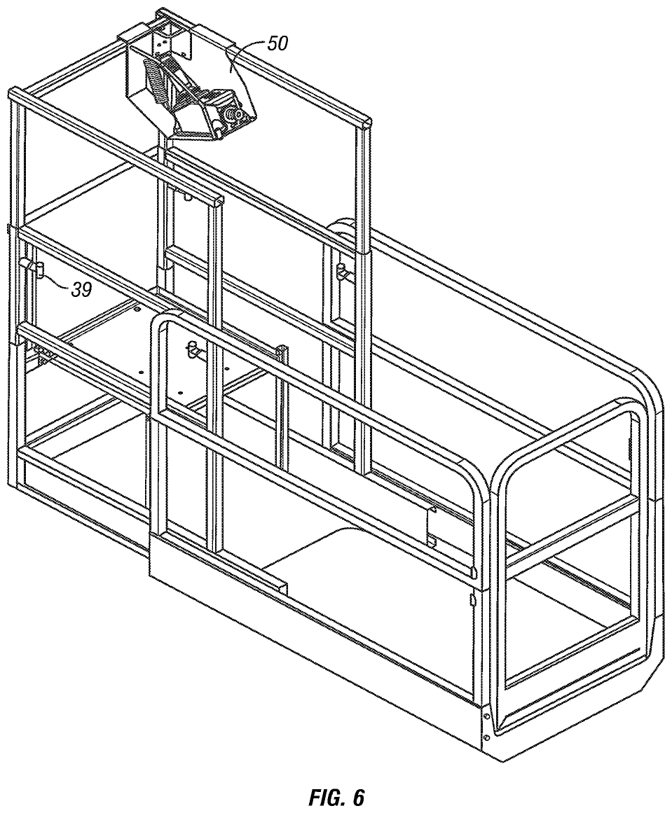

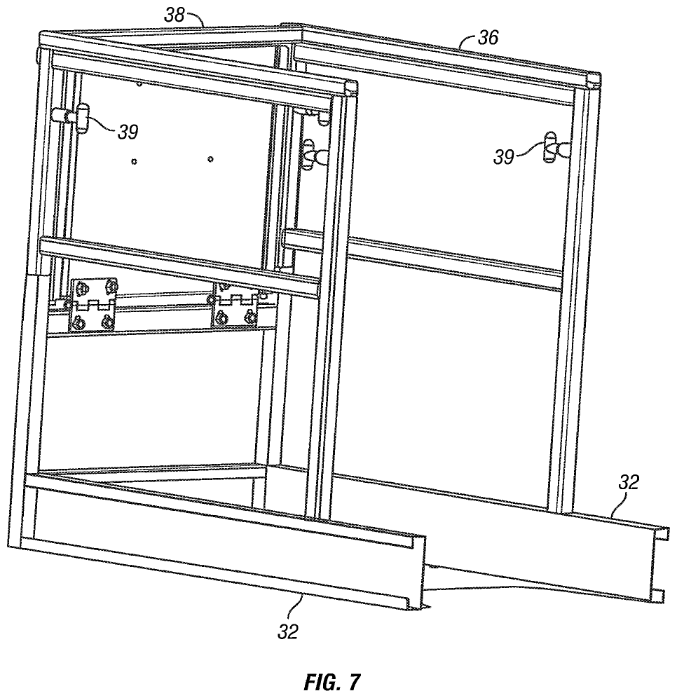

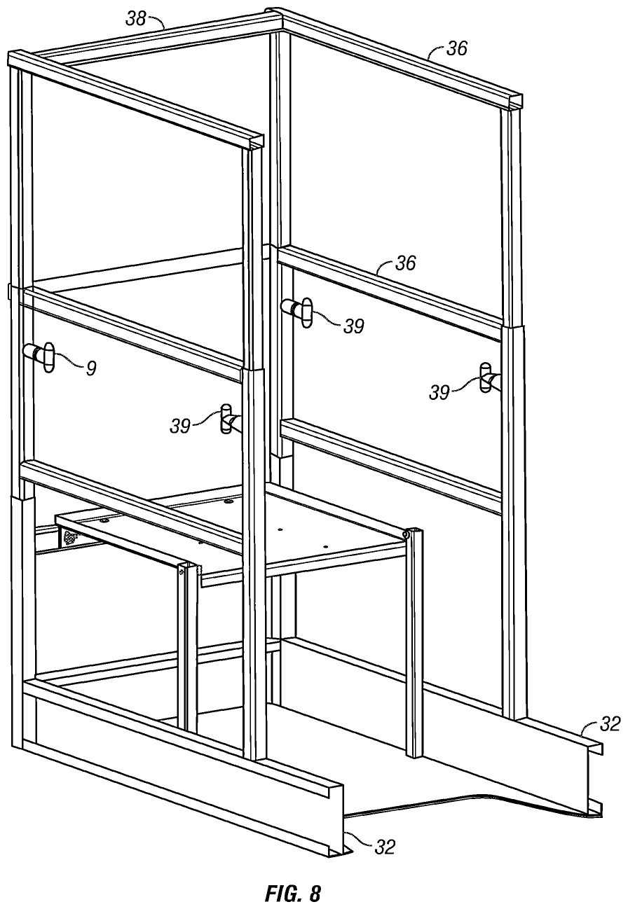

As seen in FIGS. 7 and 8, the step 40 is connected along a pivot axis to supporting structure on the extension deck such as a guardrail cross brace 38 by a hinge or hinges 42 and the step support legs 44 are preferably pivotally connected at 45 to the step 40 to be located closely alongside the step support surface when the step is pivotally raised to its stored location. The step 40 and legs 44 may be secured to a guardrail by temporary fastening means such as snap retainers, the step 40 then occupying its stored position between the vertically extending corner guardrail legs. Alternatively, it may be preferred to swing the step to a storage position below the hinges 42 instead of above. An operator control station 50 is provided in any suitable location on the extension deck 30 as seen in FIGS. 5 and 6.

The above described embodiment provides a significant improvement to more easily allow workers to minimize re-positioning of the aerial work platform and step up to better reach into and above small access openings such as those in drop ceilings to work on utilities suspended from structural ceilings.

Various modifications of the presently preferred embodiment shown and described above may be made without departing from the scope of protection of the claims which follow.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. A method of operating a work platform of a self-propelled aerial work platform apparatus, comprising:
a. laterally extending an extension deck from a main deck, said extension deck having a floor with a floor cutout adjacent to the main deck and a guardrail frame;
b. vertically extending a retractable upper frame from a lowered storage position nested in said guardrail frame to an elevated safety positions to create a vertically extended safety frame extending above said guardrail frame, wherein said retractable upper frame has three sides with an open side open to the main deck; and
c. lowering a work step from a nested storage position in said guardrail frame to a horizontally oriented work position at least one hinge supportably connecting said step to a guardrail on a side of said extension deck, wherein said retractable upper frame surrounds an area above said work step.

18. The method of claim 17, further comprising lifting said work platform from a vehicle base toward said ceiling access.

19. The method of claim 18, wherein said lifting said work platform from a vehicle base comprises extending a collapsible mechanical linkage.

20. The method of claim 17, wherein said laterally extending said extension deck comprises an operator standing on the main deck through said floor cutout and manually extending the extension deck.

21. The method of claim 17, comprising lowering at least two step support legs from said step to a step support position and positioning distal ends of said at least two support legs into depressions in said extension deck that each have a shape operable to receive a distal end of one of said at least two step support legs, wherein said at least two support leges are pivotally connected to said step.

22. The method of claim 17, wherein said step does not protrude from said guardrail frame in said nested position.

23. The method of claim 17, wherein said guardrail frame and said vertically extending safety frame together form a continuous frame around said lowered work step on said three sides.

24. The method of claim 17, wherein said upper retractable upper frame includes portions operable to nest in the guardrail frame when said retractable upper frame is retracted.

25. The method of claim 17, wherein said step being moveable from a work position in which it is horizontally oriented above said floor to a vertically oriented storage position when not in use and at least one hinge supportably connecting said step to a guardrail on a side of said extension deck.

26. A method of operating a work platform of a self-propelled aerial work platform apparatus, comprising:
a. vertically extending a retractable upper frame from a lowered storage position nested in said guardrail frame to an elevated safety positions to create a vertically extended safety frame extending above said guardrail frame, wherein said retractable upper frame has three sides with an open side open to a main deck of said self-propelled aerial work platform apparatus;
b. lowering a work step from a nested storage position in said guardrail frame to a horizontally oriented work position at least one hinge supportably connecting said step to a guardrail on a side of said extension deck, wherein a user may stand on said work step and be surrounded by said vertically extended safety frame.

27. The method of claim 26, further comprising lifting said work platform from a vehicle base toward said ceiling access.

28. The method of claim 27, wherein said lifting said work platform from a vehicle base comprises extending a collapsible mechanical linkage.

29. The method of claim 26, wherein said laterally extending said extension deck comprises an operator standing on the main deck through said floor cutout and manually extending the extension deck.

30. The method of claim 26, comprising lowering at least two step support legs from said step to a step support position and positioning distal ends of said at least two support legs into depressions in said extension deck that each have a shape operable to receive a distal end of one of said at least two step support legs, wherein said at least two support leges are pivotally connected to said step.

31. The method of claim 26, wherein said guardrail frame and said vertically extending safety frame together form a continuous frame around said lowered work step.

32. The method of claim 26, wherein said retractable upper frame has a width of less than about 24 inches.

33. The method of claim 26, wherein said upper retractable upper frame includes portions operable to nest in the guardrail frame when said retractable upper frame is retracted.

34. The method of claim 26, wherein said step being moveable from a work position in which it is horizontally oriented above said floor to a vertically oriented storage position when not in use and at least one hinge supportably connecting said step to a guardrail on a side of said extension deck.

35. The method of claim 26, further comprising laterally extending an extension deck from a main deck, said extension deck having a floor with a floor cutout adjacent to the main deck and a guardrail frame.
